(19) United States
(12) Patent Application Publication
(10) Pub. No.: US 2007/0198398 A1
(43) Pub. Date: Aug. 23, 2007

(54) ELECTRONIC COMMERCE GLOBAL RELATIONAL ACTUALIZING BARGAINING METHOD AND APPARATUS

(76) Inventors: Gerardo Rios, Egg Harbor Township, NJ (US); Manuel A. Rios, Egg Harbor Township, NJ (US); Younas Aamir, Islamabad (PK); John Bodor, Churchville, PA (US)

Correspondence Address: Mr. Walter J. Tencza Jr., Suite 3, 10 Station Place, Metuchen, NJ, 08840, US

(21) Appl. No.: 11/624,244

(22) Filed: Jan. 18, 2007

Related U.S. Application Data
(60) Provisional application No. 60/762,648, filed on Jan. 28, 2006.

(51) Int. Cl. G06Q 40/00

(52) U.S. Cl. 705/37

(57) ABSTRACT

An Internet trading apparatus and method is disclosed for use in a computerized open market community over the World Wide Web. The apparatus and method may include a web based online trading electronic core unity portal: to bid, browse, buy, grab, promote, sell, swap, trade, and track products and services registered and posted. The apparatus and method may include actions made online at an e-commerce site, whereas the site's profiles are dynamically modifying a web site's profiles within an offer and acceptance environment. Whereas the apparatus and method is further comprised of a computer program, running on a server computer, for handling, saving, and processing information acquired from electronic commerce transactions and electronic commerce negotiations between user side computers. Whereas the apparatus and method is also comprised of a computer program wherein users have the option of direct trading or proxy that allows seamlessly to integrate the power of an expert system allowed by informed consent thus providing an effective automated offer and acceptance placement means to address negotiating inquiries.

### CROSS REFERENCE TO RELATED APPLICATION(S)

The present application claims the priority of provisional application Ser. No. 60/762,648 filed on Jan. 28, 2006, by Gerardo Rios, Manuel A. Rios, Younas Amir, and John Bodor Jr. (inventors).

### FIELD OF THE INVENTION

This invention relates generally to systems and methods for providing a choice of trading platforms and more efficiency associated with electronic commerce or e-commerce.

### BACKGROUND OF THE INVENTION

Generally, electronic commerce, or e-commerce, relies upon shopping carts, online auctions, and point of sale systems services. However, these systems are plagued with inefficiencies that give only few choices of trading venues between individuals, individuals and organizations, and between organizations.

### SUMMARY OF THE INVENTION

One or more embodiments of the present invention relate to an Internet-based Electronic Trading System with automated but diverse computerized protocols that provide end-users efficiency and convenience access of trading over the Internet. One embodiment of the present invention includes an automated market bargaining Internet trading apparatus that allow a selection of bargaining and Internet trading tools that achieve improved queried automated computerized transactions while implementing alternate forms of trading mechanisms over the World Wide Web.

From the perspective of the individual, a trading apparatus in accordance with one or more embodiments of the present invention, improves trading choice venues due to its customer friendly built-in efficiencies such as: (a) improved utilization of random fluctuations in demand, (b) improved utilization of trading tools for wait—times, (c) less stress with clear transparent terms of trade, (d) specialized trading platforms, (e) effective means for educating and encouraging a user to use online knowledge-bases to address their question, and (f) cost effective means to enhance customer satisfaction.

Furthermore, one or more embodiments of the present invention provide an electronic commerce marketing system that offers a user an option to access customer service through the Internet in addition to other conventional forms of market exchange of good and services such as retailing, telemarketing, and television shopping networks. A method in accordance with an embodiment of the present invention includes guiding a user to a web site that displays, on the user's browser, web pages which provide another alternative form of information for products and services. The web pages may address a user's inquiry and may also provide the convenience of shopping without leaving the comfort of home, office, or work place. Users have thus the benefit of being able to make their choices in the convenience of their time and the choice of ordering, expediting, and receiving at the selected time.

One or more embodiments of the present invention relate to an Internet based electronic mercantile system with computerized exchange and trade protocols that provides efficient and convenient access to online trading communities. A method in accordance with an embodiment of the present invention includes a choice of electronic trading and order processing management systems that also comprises the actions made online at the e-commerce site, whereas the site's profiles are dynamically modifying a web site's profiles within an offer and acceptance environment, said environment includes computerized auctioning, buying, selling, swapping, trading, compiling, processing, and management of data input by various computer programming trading management modules, namely: 1) “Bid”—Computerized online forward demand auction 2) “LowBid”—Computerized online reverse supply auction, 3) “Deal”—Computerized online Bargaining, 4) “Grab”—Computerized online point-and-click thrift sales and buying, 5) “Swap”—Computerized online Bartering, 6) “Shop”—Computerized online shopping market baskets, 7) “PAGO”—Computerized Payment Gateway Online, and 8) “COSA”—Customer Online Service Access. These electronic trading modules function as a choice of trading venues over the World Wide Web, and achieve improved queried automated computerized transactions. Users of our computerized trading system have the option of using such trading tools by means of direct trading or by means of a hosted trading proxy (HTP) through a host computer network which may seamlessly integrate the power of an expert system allowed by the informed consent of users providing an effective automated offer and acceptance placement means to address negotiating inquiries submitted by users in a web based online trading market.

One or more embodiments of the present invention include the “Bid” computer programming trading management module, whereas users access an Internet based electronic demand and supply open market system for automated exchange, and place binding Offers through an automated forward demand auction management system.

One or more embodiments of the present invention include the “LowBid” computer programming trading management module, whereas users access an Internet based supply and demand open market system for automated exchange, and place binding Offers through a computerized online backward supply auction management system.

One or more embodiments of the present invention include the “Deal” computer programming trading management module, whereas users access an Internet based demand and supply open market system for automated exchange, whereas offers are negotiated through a computerized online bargaining management system.

One or more embodiments of the present invention include the “Grab” computer programming trading management module, whereas users access an Internet based demand and supply open market system for automated exchange, and place binding orders through a computerized thrift sales management system.

One or more embodiments of the present invention include the “Swap” computer programming trading management module, whereas users access an Internet based demand and supply open market system for automated exchange and place binding offers through a computerized bartering management system.

One or more embodiments of the present invention include the “Shop” computer programming trading management module, whereas users access an Internet based demand and supply open market system for computerized exchange, and place binding orders through an electronic shopping market basket management system.

One or more embodiments of the present invention include “COSA”, which is an acronym for Customer Online Services Access computer programming management module. In response to selections made by a user, orders may be placed and tracked through the automated customer services system, which may be available at all times to initiate or receive inquiries. This is achieved by means of a host agent server or computer program of the host agent server that provides a “NEED HELP” button on one or more web pages, which shall enable users to gain quick access to a customer online server access (COSA) should the user experience any type of difficulty.

At least one embodiment of the present invention provides a “HAS” function, an acronym meaning Host Agent Server. The host agent server may be comprised of a computer program, running on a server computer, for handling, saving, and processing information acquired from electronic commerce transactions and electronic commerce negotiations between user side computers. The host agent server may provide infrastructure to support the operation of the host trading proxy. Furthermore, the host agent server or computer program of the host agent server may also provide a “NEED HELP” button on one or more web pages, which shall enable users to gain quick access to a customer online server access (COSA) should the user experience any type of difficulty.

Another aspect of one or more embodiments of the present invention is the PAGO, which is an acronym for Payment Authorizing Gateway Online computer programming management module, comprising a computer software program providing electronic invoicing for payments and receivables, and payment processing through an electronic banking gateway between individuals, individuals and organizations, and between organizations.

### BRIEF DESCRIPTION OF THE DRAWINGS

FIG. 1 shows a diagram of a method apparatus, and system in accordance with an embodiment of the present invention;

FIG. 2 shows a diagram of processing for various modules in accordance with an embodiment of the present invention;

FIG. 3 is a diagram concerning processing for a Bid! module and/or method;

FIG. 4 is a diagram concerning processing for a LowBid! module and/or method;

FIG. 5 is a diagram concerning processing for a Deal! module and/or method;

FIG. 6 is a diagram concerning processing for a Grab! module and/or method;

FIG. 7 is a diagram concerning processing for a Swap! module and/or method;

FIG. 8 is a diagram concerning processing for a Shops! module and/or method;

FIG. 9 is a diagram concerning processing for a PAGO Payment Processing module and/or method;

FIG. 10 is a diagram concerning processing for a COSA module and/or method;

FIG. 11 is a block diagram of components for an apparatus in accordance with an embodiment of the present invention;

FIG. 12 is a diagram of a home page image which can appear on a computer screen;

FIG. 13 is a diagram of a bid function image, which can appear on a computer screen;

FIG. 14 is a diagram of a login image, which can appear on a computer screen;

FIG. 15 is a diagram of a register image, which can appear on a computer screen;

FIG. 16 is a diagram of a services image, which can appear on a computer screen; and

FIG. 17 is a diagram of a contact us image which can appear on a compute screen.

### DETAILED DESCRIPTION OF THE DRAWINGS

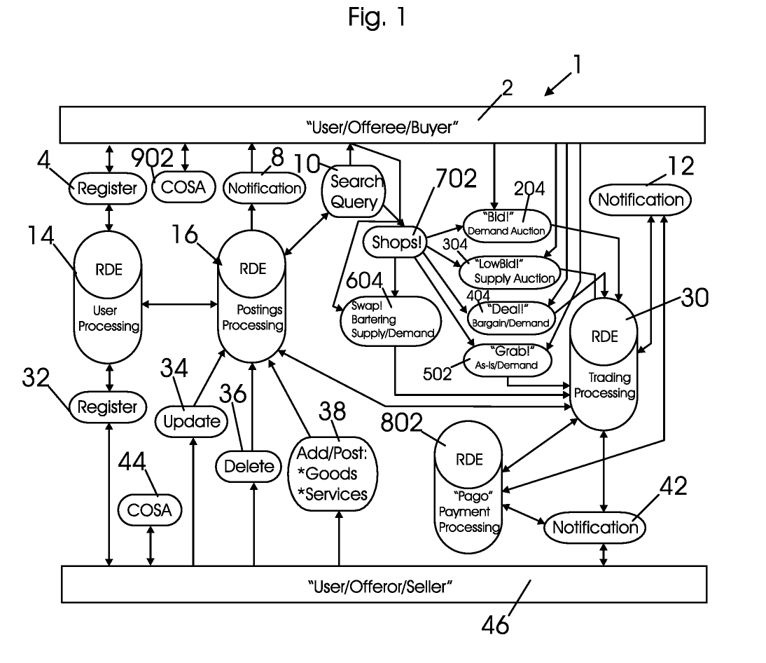

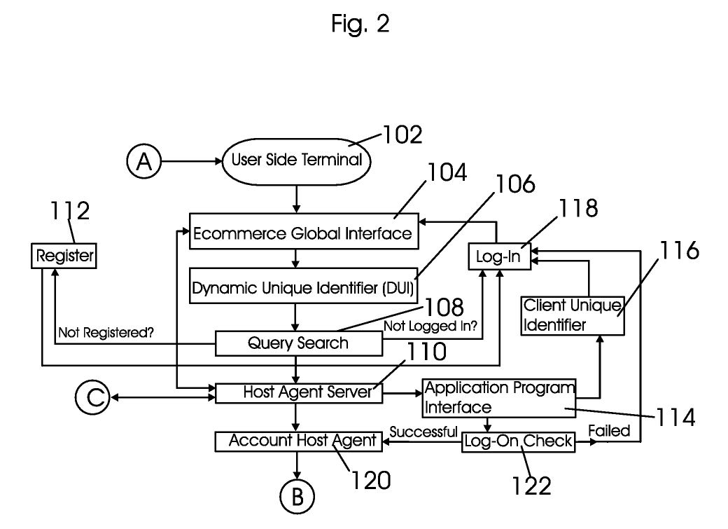

FIG. 1 diagram 1 depicts the methods by which the apparatus manages the logistical database flow of online trading in accordance with an embodiment of the present invention. The diagram 1 shows a user/offeree/buyer linked to a gateway/host computer to a register 4 to an online trading community, accessing a COSA (customer online service access) module 902, receiving feedback through a notification module 8, receiving feedback from a search query module 10, accessing a Bid! module 204, accessing a LowBid! module 304, accessing a Deal! module 404, accessing a Grab! module 502, and accessing a Swap! module 604. The modules 902, 8, 10, 204, 304, 404, 502, and 604 may each include subordinate computer programming logic routine steps running on a web server comprised of a computer acting as an electronic host agent server (HAS) 110, shown in FIG. 2, over an online trading community. The system shown by diagram 1 may be called “e-commerce global relation actualizing bargaining script”.

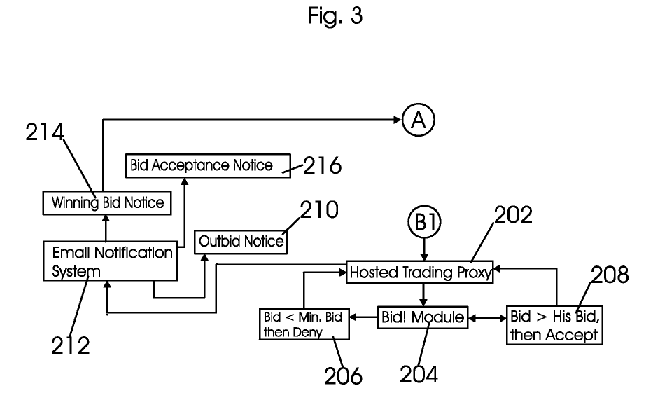

The host agent server 110, shown in FIG. 2, hosts a web site through which a user can schedule a query session through an e-commerce global interface (EGI) 104 shown in FIG. 2, and access information stored at both the Host Server Agent and Hosted Trading Proxy which forms a Relational Database Exchange (RDE) of categories of listings or postings through a physical hardware host computer network, such as RDEs' 14, 16, 30, or 802 shown in FIG. 1. The e-commerce global interface 104, shown in FIG. 2, is operated by a host agent server, such as 110 shown in FIG. 2, programmed by a computer program to process offers and acceptances in accordance with an embodiment of the present invention. The HAS web server computer 110, shown in FIG. 2, runs concurrent with the hosted trading proxy (HTP) 202, shown in FIG. 3, as an offer and acceptance management system which may be run through a host computer network online with the Internet to be accessed by users of the online trading community.

A user accesses the e-commerce graphical interface 104, shown in FIG. 2, which encumbers a domain website registry running on a host computer network acting as a web server programmed by HTML displaying web pages. The user side computer or user/offeree/buyer computer 2 shown by FIG. 1, may be, for example, a personal computer, a palmtop device configured with a web browser, or a wireless device that may access web pages using wireless applications protocol (WAP). The user side computer or user/offeree/buyer computer 2 in FIG. 1, through an internet access service provider (ISP), accesses the host server agent (HAS) 110, shown in FIG. 2, by computer Log-in to a physical hardware host computer network online with the Internet. Access through an ISP can include a combination of networks, such as a wireless network combined with Internet.

Likewise, the e-commerce domain website registry running the computer programming management modules and programming functions shown by FIGS. 2-10, can be accessed through the Internet through an Internet Access Service Provider (ISP), which accesses the host server agent (HAS) 110, shown in FIG. 2, by computer Log-in to a physical hardware host computer network online with the Internet and is visible through the user's side web browser running on a the computer 2 on the computer network capable of accessing and displaying web pages.

FIG. 1 illustrates an embodiment of the present invention including the primary functions, modules, or methods of Bid! 204, Lowbid! 304, Deal! 404, Grab! 502, Swap! 604, Shop! 702, PAGO 802, and the various programming components CUI 116, GUT 110, DIT 106, and HAS 110, shown in FIG. 2; HTP 202, shown in FIG. 3; RDE 14,16,30, and 802, shown in FIG. 1; and EGI 104, API 114, and AHA 120, shown in FIG. 2, associated with routines and sub-routines of the compiling, processing, and management of data input and output.

Referring again to FIG. 1, the register 4, is linked to RDE user processing 14, which is linked to a register 32. The notification module 8 is linked to RDE postings processing 16. The RDE postings processing 16 is linked to RDE 14, to an update module 34, a delete module 36, an add/post module 38, an RDE trading processing module 30, the notification module 8, and the search query module 10. The search query module 10 is also linked to the shops! module 702. The shops! module 702 is linked to the swap! module 604, the bid! module 204, the Lowbid! module 304, the Deal! module 404, and the Grab! module 502. The RDE module 30 is linked to the swap! module 604, the grab! module 502, the RDE module 16, the bid! module 204, the Lowbid! module 304, the Deal! module 404, a notification module 12, a notification module 42, and the RDE pago payment processing 802. The registers 4 and 32 are comprised of a sign-up gateway for both new account validation or gateway session entry via both the Host Server Agent and Hosted Trading Proxy which forms a Relational Database Exchange (RDE) through a physical hardware host computer network module 14.

Diagram 1 also shows user/offeror/seller computer 46 which is linked to a register 32, a COSA module 44, an update module 34, a delete module 36, an add/post module 38, an RDE module 802, and a notification module 42. The modules 44, 34, 36, 38, 802, and 42 may include computer software running on a dedicated server acting as an online access gateway relational database exchange (RDE) through a physical hardware host computer network module 14.

FIG. 2 shows a diagram of processing for various modules in accordance with an embodiment of the present invention. A user through a user side terminal 102 accesses the e-commerce graphical interface 104 running on the Host Agent dedicated server acting as an Relational Database Exchange (RDE) through a physical hardware host computer network module 14, capable of accessing and displaying web pages.

The user side computer's (computer 2 in FIG. 1) IP (internet protocol) address is tagged with a Dynamic Unique Identifier (DUI) at step 106 to enable the online host agent server 110 to track an encounter session.

The user, through the user side terminal 102, queries and searches at step 108 through a Database located at Relational Database Exchange (RDE) through a physical hardware host computer network module 16, of products or services for trading purposes.

New users that decide to trade are prompted to open an account at step 112 using personal alpha numerical identifying information including credit card or banking information and verifiable email address which are then stored at both the host agent server 110 and a hosted trading proxy, such as 202 in FIG. 3, by means of Relational Database Exchange (RDE) through a physical hardware host computer network module 802.

Newly registered users are then provided an account access key entry code by the host trading proxy, such as 202 in FIG. 3, via email and are then prompted to go to the website URL to enter a key entry code, at step 8 in FIG. 1. Once the key entry code is entered by a user, the host agent server 110 proceeds to cross reference the key entry code with the dynamic unique identifier provided by the host agent server as a second level security identifier (SI).

Users are then prompted to register a client unique identifier at step 116 on the website for trading purposes. User side computers (such as computer 2 of FIG. 1) that fail to pass the second level security identifier session are denied access at step 118 FIG.2, and are posted at the non-originating (NO) security database managed by number 110 FIG. 2.

User sessions that fail to clear the second level security identifier (SI) are then prompted the choice of terminating their session at step 122 in FIG. 2, or to go to the customer online service access (COSA) module 902 for a third level security identifier and are asked to provide additional identifying information to a customer service account manager for review. Previously registered users need only to enter their Identifier descriptor (ID) account name and the key entry code on the website to access the trading module number 30 FIG. 1. Once the key entry code is entered by a user, the host agent server 110 proceeds to cross reference the key entry code with the Dynamic Unique Identifier (DUI) provided by the host agent server 110 as a second level security identifier (SI). Users that pass the second level security are provided entry access to the trading module of their choice to continue their active trading session. The web server computer number 110 FIG. 2, runs the hosted trading proxy computer software program or module, such as 202 in FIG. 3, as an offer and acceptance management system through a computer network Relational Database Exchange (RDE) through a physical hardware host computer network 30, shown in FIG. 1, online with the Internet to be accessed by Users or user computers such as computer 2 of FIG. 1, forming an Online Trading Community.

In the case of the Bid! module 204, the method proceeds from step B in FIG. 2 to Step B1 in FIG. 3. Credit card or banking information and verifiable email address, for a user, are stored at the hosted trading proxy 202, which may include computer memory, by means of a relational database exchange (RDE) computer software routine, function or module, such as module14 number, FIG.1. Users that pass second level security, at step 122 of FIG. 2, and are provided entry access to the trading module of their choice, to continue their active trading session, which in this case is the Bid! module 204 shown in FIG. 3. At step 206 of FIG. 3, if a bid is less than the minimum bid than the bid is denied and control is returned to the hosted trading proxy at step 202. At step 208 of FIG. 3, if the forward looking bid offer is the highest or equal to the reserve price after the electronic auction has ended, then the highest bid is accepted by the control hosted trading proxy 202. Upon acceptance of the bid was accepted there is an e-mail notification at step 212, a bid notice to the higher than the reserve or lowest bid is made at step 214, an outbid notice to the lower than the reserve or lower than the highest bid is made at step 210 and a bid acceptance notice at step 216. Control of the trading process is administered by the Account Host Agent in step B of FIG. 2.

FIG. 3 illustrates an example of a preferred embodiment of an online forward demand auction process (or bid! module or computer software process) wherein offer and acceptance bids are made between individuals, individuals and organization, and between organizations, in viewable and readable output format by a managed computer server and the user side computers in order to carry out transactions over the internet and intranets in a managed computerized open market system over the World Wide Web.

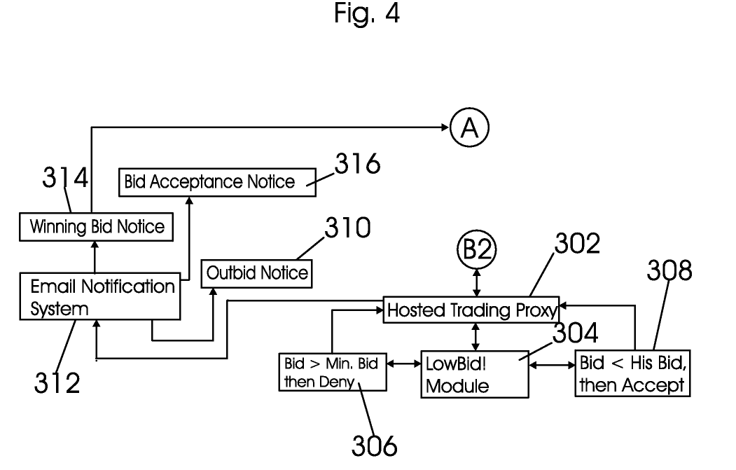

In the case of the Lowbid! module 304, the method proceeds from step B in FIG. 2 to Step B2 in FIG. 4. Credit card or banking information and verifiable email address for a user, are stored at the hosted trading proxy 302 by means of a relational database exchange (RDE) function or computer software program. Users that pass second level security, at step 122 of FIG. 2, and are provided entry access to the trading module of their choice, to continue their active trading session, which in this case is the LowBid! Supply module 304 shown in FIG. 4. At step 306 of FIG. 4, if the bid is greater than the minimum bid then it is denied and control is returned to the hosted trading proxy 302. At step 308 of FIG. 4, if the bid offer is equal to or less than the minimum acceptance low bid, then it is accepted and control is returned to the hosted trading proxy 302. If the supply bids are equal to or lower than the minimal accepted low price, there is an e-mail notification at step 312, a wining bid notice is made upon closing of the supply side low bid at step 314, an outbid notice at step 310 and a bid acceptance notice at step 316. Control of the trading process is administered by the Account Host Agent in step B of FIG. 2.

FIG. 4 illustrates an example of the preferred embodiment of an online backward supply auction process wherein offer and acceptance bids are made between individuals, individuals and organizations, and between organizations, in viewable and readable output format by a managed server and the user side computers in order to carry out transactions over the Internet and Intranets in a managed computerized open market system over the World Wide Web.

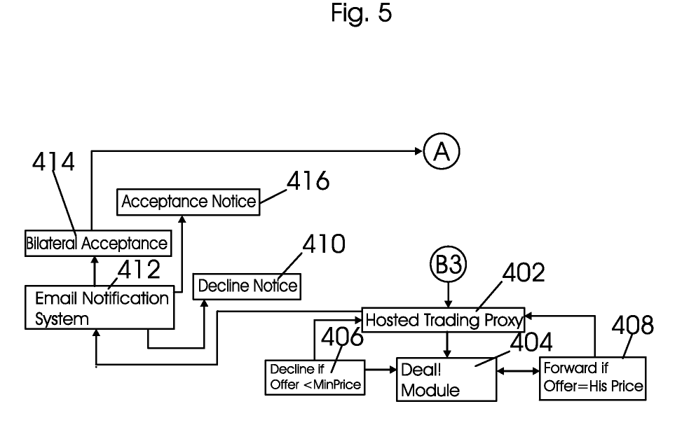

In the case of the Deal! module, the method proceeds from step B in FIG. 2 to Step B3 in FIG. 5 Credit card or banking information and verifiable email address for a user are stored at the hosted trading proxy 402 by means of a relational database exchange (RDE) function. Users that pass second level security, at step 122 of FIG. 2, and are provided entry access to the trading module of their choice, to continue their active trading session, which in this case is The Deal! module 404 shown in FIG. 5. At step 406 of FIG. 5, if a direct offer is less than the acceptance price then the offer is declined and control is returned to the hosted trading proxy 402. At step 408 of FIG. 5, if the offer is equal to the acceptance price set by the offeree, then the offer is forwarded by the hosted trading proxy 402 as an e-mail notification at step 412 waiting for bilateral acceptance at step 414, and an acceptance notice at step 416, and control is returned to step A of FIG. 2. If there was a decline, there is a decline notice sent at step 410 to logical loop negotiating sequence at step 408 FIG.5. If no action is taken after being declined at step 410, no further action is needed unless both sides begin renegotiating at step 408 FIG.5. Control of the trading process is administered by the Account Host Agent in step B of FIG. 2.

FIG. 5 illustrates an example of the preferred embodiment of a computer process for online bargaining over computerized platforms for exchange between individuals, individuals and organizations, and between organizations, in viewable and readable output format by a managed server and the user side computers in order to carry out transactions over the Internet and Intranets in a managed computerized open market system over the World Wide Web.

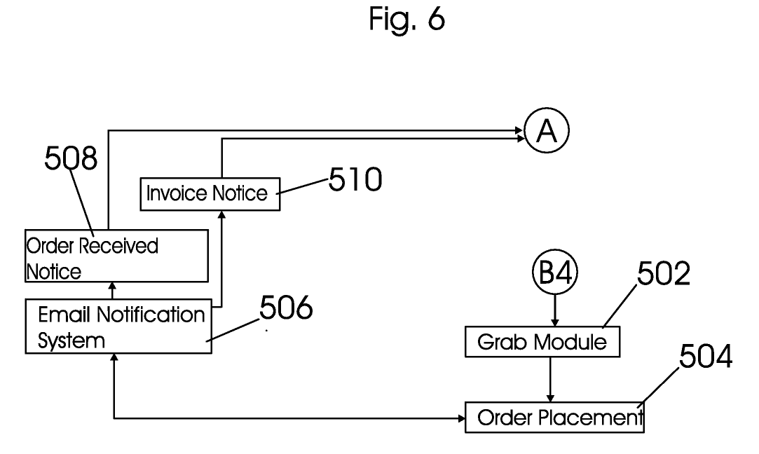

In the case of the Grab! module 502, the method proceeds from step B in FIG. 2 to Step B4 in FIG. 6. Credit card or banking information and verifiable email address for a user are stored at the hosted trading proxy 402 FIG. 5, by means of a relational database exchange (RDE) function FIG. 1 number 14, such being is a computer software routine function. Users that pass second level security, at step 122 of FIG. 2, and are provided entry access to the trading module of their choice, to continue their active trading session, which in this case is the Grab! module 502 shown in FIG. 6. At step 504 of FIG. 6, an order placement for low priced clearance merchandise is made. At step 506 an e-mail notification is given, at step 508, an order received notice is given, and at step 510 an invoice notice is given. Control of the trading process is administered by the Account Host Agent in step B of FIG. 2.

FIG. 6 illustrates an example of the preferred embodiment of a computer process for an online bargain sale platform for trade between individuals, individuals and organizations, and between organizations, in viewable and readable output format by a managed server and user side computers in order to carry out transactions on the Internet and Intranets in a managed computerized open market system over the World Wide Web.

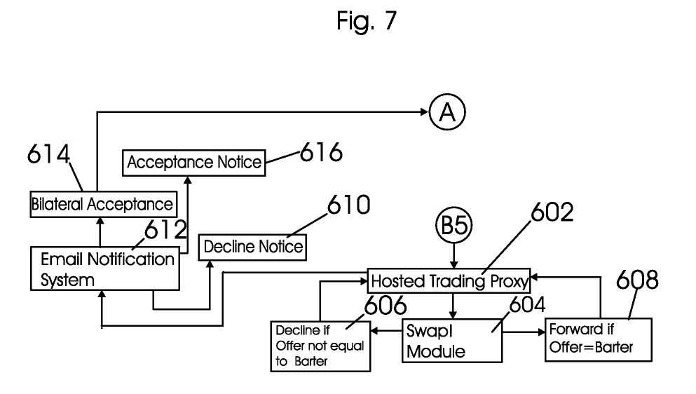

In the case of the Swap! module, the method proceeds from step B in FIG. 2 to Step B5 in FIG. 7. Credit card or banking information and verifiable email address for a user are stored at the hosted trading proxy 402 FIG. 5, by means of a relational database exchange (RDE) function FIG. 1 number 14, such being is a computer software routine function. Users that pass second level security, at step 122 of FIG. 2, and are provided entry access to the trading module of their choice, to continue their active trading session, which in this case is the Swap! module 604 shown in FIG. 7. At step 608 of FIG. 7, offers are submitted through the website directly by the Offeree to the Offeror for bargaining and acceptance terms, notices being sent directly via email notification. At step 606 of FIG. 7, if an offer submitted by the Offeree is not equal to bartering terms asked by the Offeror, the Offeror may decline the offer at which instance and control is returned to the hosted trading proxy 602 to free up the bartering posting on the website thus allowing other would be offerees to negotiate with the offeror. If the offer equals the bartering terms, then the offeror makes acceptance directly through the hosted trading proxy 602. Upon acceptance, there is an e-mail notification at step 612, a bilateral acceptance at step 614 and control is returned to step A of FIG. 2, and an acceptance notice at step 616. If there was a decline, there is a decline notice at step 610. Control of the trading process is administered by the Account Host Agent in step B of FIG. 2.

FIG. 7 illustrates an example of the preferred embodiment of a computer process for electronic bartering over computerized platform for trade between individuals, individuals and organizations, and between organizations, in viewable and readable output format by a managed server and a user computer in order to carry out transactions over the Internet and Intranets in a managed computerized open market system over the world wide web.

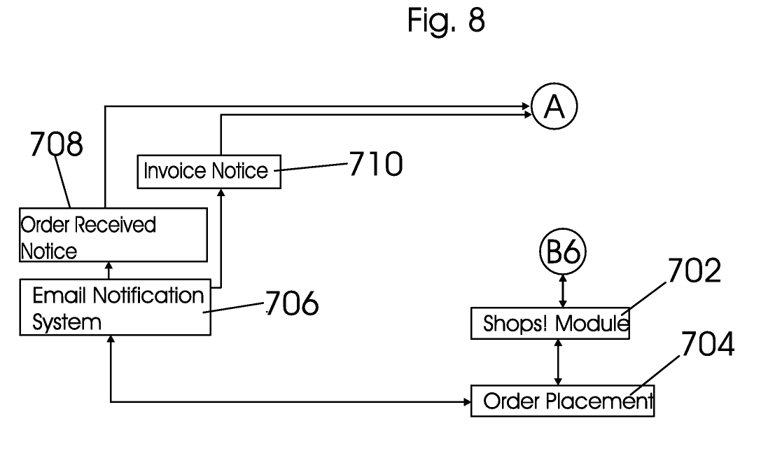

In the case of the Shop! module 702, electronic online shopping market baskets method proceeds from step B in FIG. 2 to Step B6 in FIG. 8. A plurality of transactions information are stored at the hosted trading proxy 402 FIG. 5, by means of a relational database exchange (RDE) function FIG. 1 number 14, whereas the host agent server adds, stores, and sends a payment invoice, such being a computer software routine function. Users that pass a level security, at step 122 of FIG. 2, and are provided entry access to the electronic online shopping market baskets module to continue their active trading session, which in this case is the Shop! module 702 shown in FIG. 8. At step 704 of FIG. 8, an order placement made at electronic retail shopping modules. At step 706 an e-mail notification is given, at step 708, an order received notice is given, and at step 710 an invoice notice is given. Control of the trading process is administered by the Account Host Agent in step B of FIG. 2.

FIG. 8 illustrates an example of the preferred embodiment of a computer process to provide electronic shopping bags for trade between individuals, individuals and organizations, and between organizations, in viewable and readable output format by a managed server and the user side computers in order to carry out transactions over the Internet and Intranets in a managed computerized open market system.

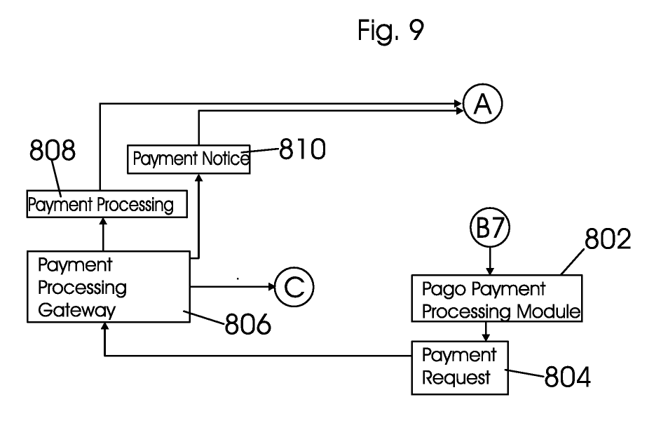

In the case of the PAGO Payment Processing Module 802, the method proceeds from step B in FIG. 2 to step B7 in FIG. 9. Credit card or banking information and verifiable email address, for a user, are stored at the hosted trading proxy number 202 FIG. 3, by means of a relational database exchange (RDE) function number 802 FIG. 1. Users that pass second security, at step 122 of FIG. 2, are provided entry access to the trading module of their choice, to continue their active trading session, which in this case is the PAGO payment module 802 shown in FIG. 9. At step 804 of FIG. 9, a payment request is made at step 806 which a payment processing gateway is made which is a third party Banking Institution. Control is returned to step A of FIG. 2. At step 808 a payment processing is performed. At step 810 a “paid in full” notice is sent to the to the Users side computers by the third party Banking and to the Host Agent Server step C on FIG. 2 to update relational databases.

FIG. 9 illustrates an example of the preferred embodiment of a computer process to create a payment receivable and payable gateway for online electronic invoicing and payment processing between individuals, individuals and organizations, and between organizations in viewable and readable output format by a managed server and the user side computers in order to carry out payment transactions over the Intranets in a managed computerized open market system.

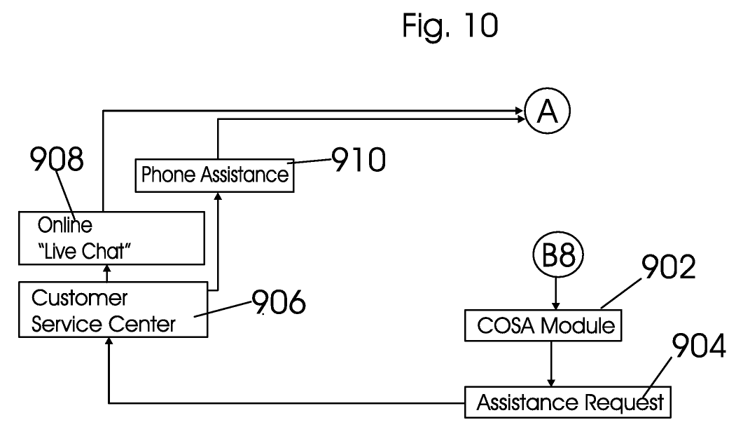

In the case of the COSA Module 902, the method proceeds from step B in FIG. 2 to Step B8 in FIG. 10. Credit card or banking information and verifiable email address, for a user, are stored at the hosted trading proxy number 202 FIG. 3, by means of a relational database exchange (RDE) function number 802 FIG. 1. Users that pass second security, at step 122 of FIG. 2, are provided entry access to the trading module of their choice, to continue their active trading session, which in this case is The COSA module 902 shown in FIG. 10. At step 904 of FIG. 10, an assistance request is made. At step 906 Customer Service Center is notified by the Users of the system via electronic means regarding trading potential problems delaying and disrupting the trading system. At step 908 an online live chat is executed upon request by end users. At step 910 phone assistance is performed upon request by end users. Control is then returned to step A of FIG. 2.

FIG. 10 illustrates an example of the preferred embodiment of the customer online service access (COSA) module 902 that operates as a command and central center to manage and coordinate all the functions performed by a customer service management system or computer software process. Module or computer software program 902 supervises the activities of the following functions: customer service scheduler, scheduler, service agents scheduler, knowledge base manager, and the user registration and profile records services Archive. The customer service scheduler is a computer software procedure or function that operates and maintains the schedules for all customer service voice sessions, including those initiated by “NEED HELP” requests submitted by users searching a selection-oriented knowledge base. The service agents scheduler is a computer software procedure or function that operates and maintains the schedules for all service agents. An important part of this step is to educate and encourage the user (of user computer 2 in FIG. 1) to use the Internet option to the extent possible and overcome the bad personal experiences some users may have had with poorly designed Internet based systems.

If the inquiry relates to a service such reference can be user identification, account number or any other information necessary to uniquely identify, for the purposes of the customer service scheduling system, the recipient of the service. If the inquiry relates to a problem, the user preferably selects from an expandable selection menu the general nature of the problem. Furthermore, the user is preferably prompted to answer any applicable questions that may further isolate the problem. Likewise, the user is offered the opportunity to decide whether or not to access the selection-oriented knowledge base before attempting to schedule a phone session with a customer service agent. At any time during the search the user can continue with step by clicking a “NEED HELP’ button to contact a customer service agent. The NEED HELP’ button is preferably prominently displayed on each web page. The NEED HELP! button increases the level of the users confidence in the system. It offers the user the comfort that computer intelligence is always supplemented by human intelligence, whenever needed, to efficiently resolve the users inquiry.

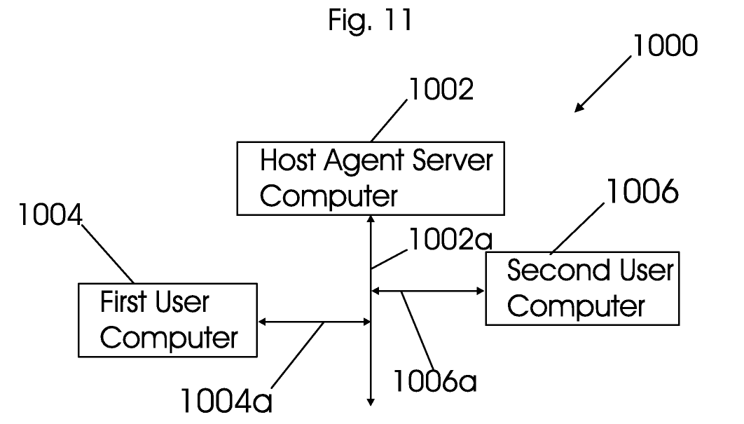

FIG. 11 is a block diagram 1000 of components for an apparatus in accordance with an embodiment of the present invention. The apparatus shown in FIG. 11 includes a host agent server computer 1002, a first user computer 1004, and a second user computer 1006. The first user computer 1004 is connected to the host agent server computer 1002 via communication lines 1002a and 1004a. The second user computer 1006 is connected to the host agent server computer 1002 via communication lines 1002a and 1006a. The communication lines 1002a, 1004a, and 1006a may be wireless, hardwired, and may include fiber optics, a software connection, or any other type of communications line or channel. The host agent server computer 1002 may be similar to and may perform the same functions as the host agent server 110 shown in FIG. 2.

The host agent server computer 1002, the first user computer 1004 and the second user computer 1006 may each include a computer memory, an interactive device (such as a keyboard and/or computer mouse), and a display device, computer screen, or monitor.

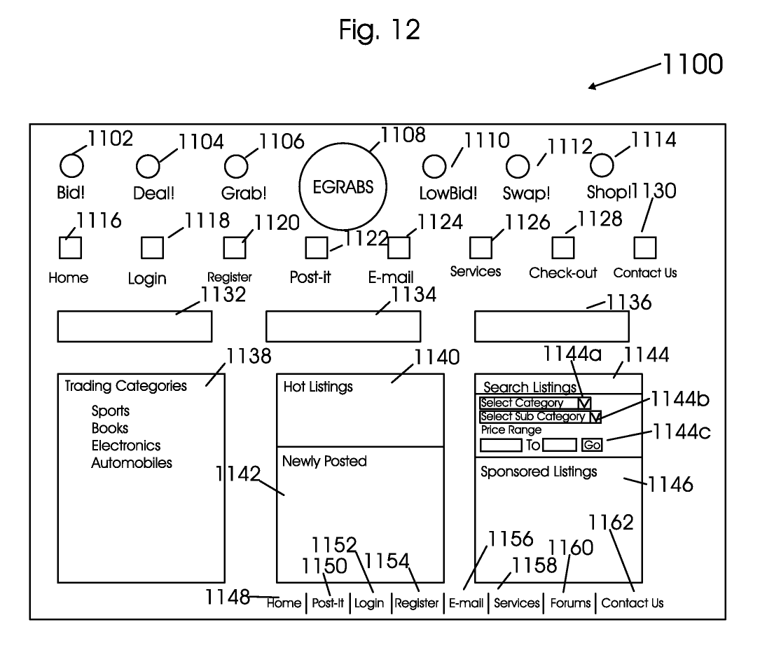

FIG. 12 is a diagram of a home page image 1100 which can appear on a computer screen, such as a screen of the first user computer 1004 or the second user computer 1006. The image 1100 may be supplied to the first user computer 1004 or the second user computer 1006 by the host agent server 1002. The home page image 1100 includes fields 1102, 1104, 1106, 1108, 1110, 1112, 1114, 1116, 1118, 1120, 1122, 1124, 1126, 1128, and 1130, which typically include an icon and a designation for Bid!, Deal!, Grab!, Egrabs!, LowBid!, Swap!, Shop!, Home, Login, Register, Post-it, E-mail, Services, Check-out, and Contact Us, respectively. Each of the fields 1102-1130 when clicked on (using a computer mouse and a computer cursor on the screen) causes a new image to appear on a computer screen, of for example, first user computer 1004.

The home page image 1100 also includes advertising fields 1132, 1134, and 1136 which may include advertisements which can be clicked on. The home page image 1100 also includes fields 1138, 1140, 1142, 1144, and 1146. Field 1138 shows a list of trading categories. Field 1140 shows list of hot items. Field 1142 shows newly posted listing of goods or services. Field 1144 shows a search window. The search window or field 1144 includes a field 1144a for selecting a category for a search. The window 1144 also includes a field 1144b for selecting a sub-category for a search. The window 1144 also includes a field 1144c for entering a price range for items sought. A “Go” button in field 1144c, when clicked begins a query within a specified price range set by a user offeree on varied electronic commerce listing venues of the system within the intranet database available on the host agent server 1002 of the items posted by offerors. The field 1146 shows sponsored listings of items.

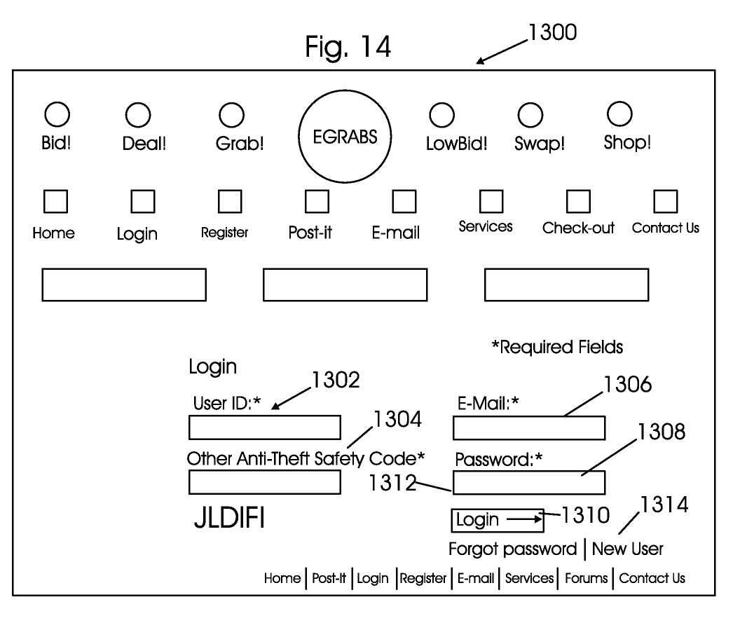

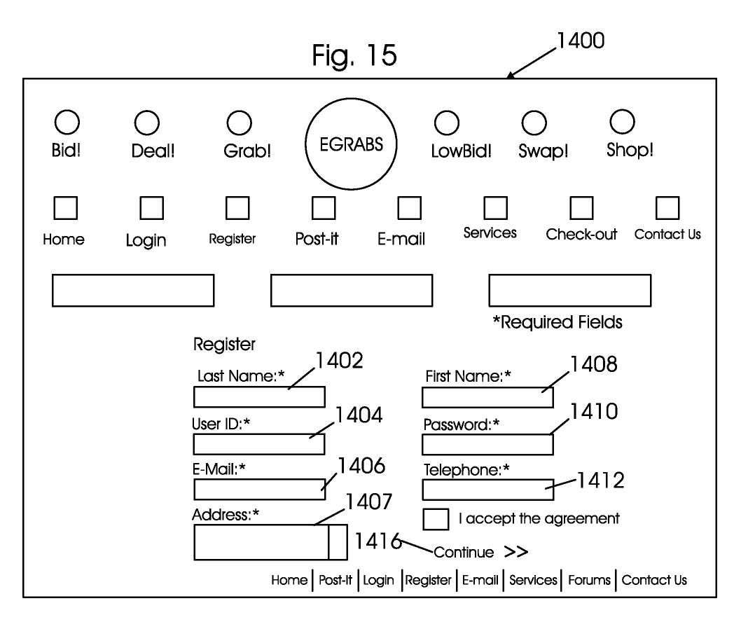

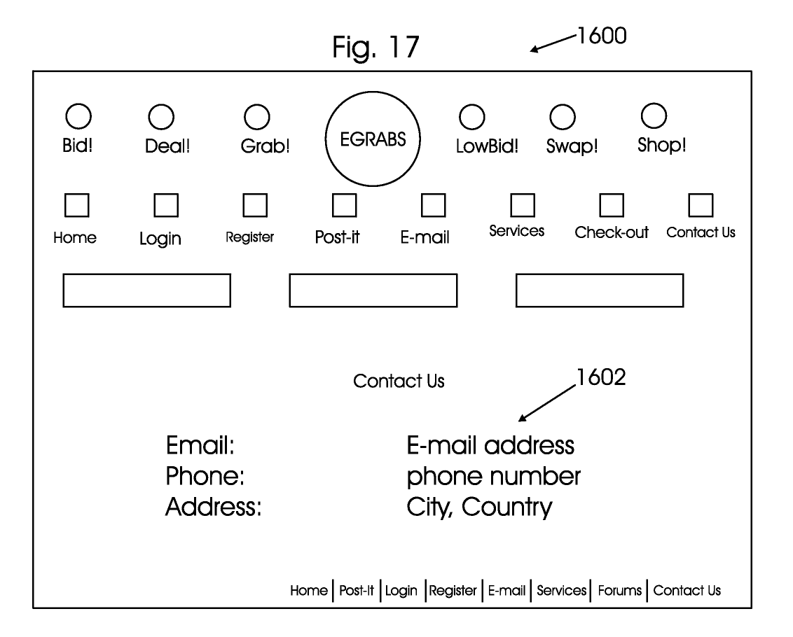

Fields or links 1148, 1150, 1152, 1154, 1156, 1158, 1160, and 1162 can be clicked on to perform various functions. Field 1148, like field 1116, causes the home page 1100 to be displayed on the computer monitor, such as a computer monitor of first user computer 1004. Field 1150, like field 1122 causes a post-it image, not shown to be displayed. Field 1152, like field 1118, causes a login image to be displayed such as in FIG. 14. Field 1154, like field 1120, causes a register image, such as in FIG. 15 to be displayed. Field 1156, like field 1124, causes an e-mail image to be displayed. Field 1158, like field 1126, causes a services image to be displayed. Field 1160 causes a forums image to be displayed. Field 1162, like field 1130, causes a contact us image, such as in FIG. 17 to be displayed.

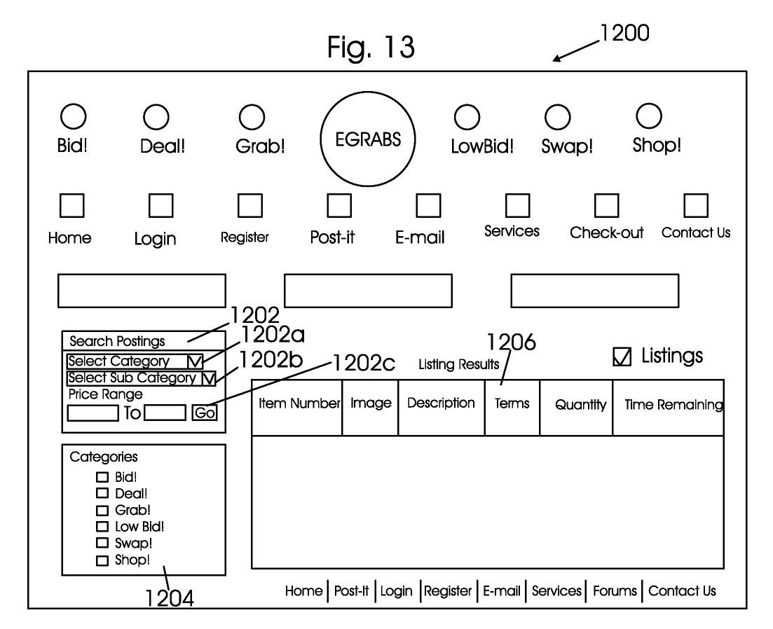

FIG. 13 is a diagram of a bid function image 1200, which can appear on a computer screen, such as a computer screen of the first user computer 1004 or the second user computer 1006. The image 1200 appears when an icon or designation of the Bid! field 1102 shown in FIG. 12 is clicked on.

The image 1200 includes fields similar to the fields 1102-1136 shown in FIG. 12. The image 1200 also includes fields 1202, 1204, and 1206. Field 1202 refers to search postings. Field 1202a allows an individual to insert a category, via a computer mouse or computer keyboard which is part of first or second user computers 1004 and 1006, for searching for a bid. Field 1202b allows an individual to insert a sub category for searching a bid. Field 1202c allows an individual to insert a price range for searching a bid. A “Go” button is shown in field 1202c for starting the search. A memory of the host agent server 1002 may be searched or a search of the internet may be performed. Field 1204 show the categories of items which can be searched on the host agent server 1002 or on the internet. Field 1206 shows search results. The image 1200 also includes fields similar to fields 1148-1162 shown in FIG. 12.

FIG. 14 is a diagram of a login image 1300, which can appear on a computer screen, such as a computer screen of first user computer 1004. The login image includes fields similar to fields 1102-1136 and 1148-1162 shown in FIG. 12. The diagram 1300 also includes fields 1302, 1304, 1306, 1308, 1310, 1312, and 1314. Field 1302 allows for entry of a user identification code. Field 1304 allows for entry of an anti-theft safety code. Fields 1306, 1308, and 1310 allow for entry of an e-mail address, a password, and for logging in, respectively. Field 1312 can be clicked on if the user has forgotten his or her password. Field 1314 can be clicked on if this is a new user.

FIG. 15 is a diagram of a register image 1400, which can appear on a computer screen, such as a computer screen of the first user computer 1004. The register image 1400 includes fields similar to fields 1102-1136 and 1148-1162 shown in FIG. 12. The register image 1400 also includes fields 1402, 1404, 1406, 1407, 1408, 1410, 1412, 1414, and 1416. Fields 1402, 1404, 1406, and 1407 can be used to enter a last name of an individual, a user identification code, an e-mail address for the user, and a mailing address for a user. Fields 1408, 1410, and 1412 can be used to enter a first name, password, and a telephone number for a user. Field 1414 can be clicked on to accept an agreement regarding use of a web site. Field 1416 can be clicked on to continue to the next appropriate image or section.

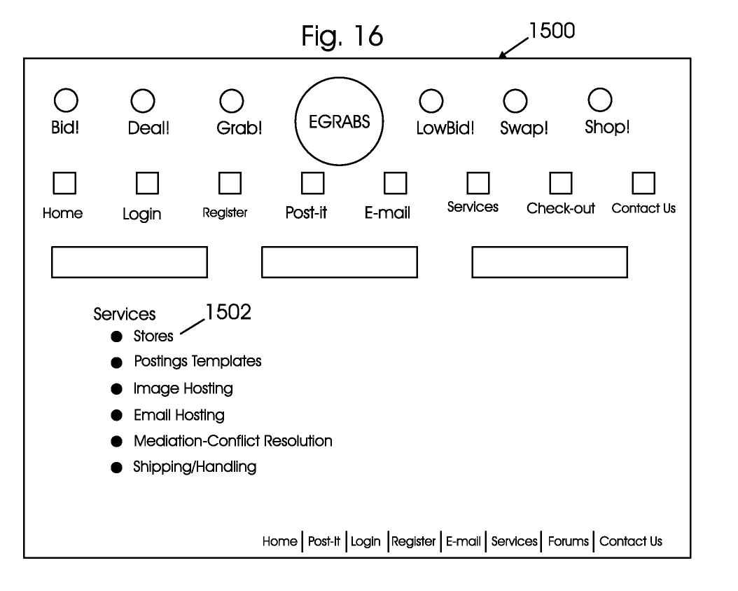

FIG. 16 is a diagram of a services image 1500, which can appear on a computer screen, such as a computer screen of the first user computer 1004. The services image 1500 includes fields similar to fields 1102-1136 and 1148-1162 shown in FIG. 12. The services image 1500 also includes field 1502, which shows the services available.

FIG. 17 is a diagram of a contact us image 1500, which can appear on a computer screen, such as a computer screen of the first user computer 1004. The contact us image 1500 includes fields similar to fields 1102-1136 and 1148-1162 shown in FIG. 12. The contact us image 1500 also includes field 1602, which shows contact information for an organization or individual running a system, method, and apparatus in accordance with the present invention. The field 1602 may include an e-mail address, a phone number, and an address including identification of city and country.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

We claim:

1. An apparatus comprising
a host agent server computer;
a first user computer which is in communication with the host agent server computer so that the first user computer can access the host agent server computer;
and a second user computer which is in communication with the host agent server computer so that the second user computer can access the host agent server computer;
and wherein the host agent server computer is programmed to process transactions between the first user computer and the second user computer.

2. The apparatus of claim 1
wherein the host agent server computer is programmed to process and manage information values and attributes of a non-numeric nature, and information comprising values and attributes of a numeric nature.

3. The apparatus of claim 1
wherein the host agent server computer is programmed to automatically compile, process, and manage databases from the first user computer and the second user computer using a plurality of programming functions.

4. The apparatus of claim 1
wherein the host agent server computer is programmed to cause an electronic commerce global interface in hyper text markup language to be displayed on a computer monitor of the first user computer.

5. The apparatus of claim 1
wherein the host agent server computer is comprised of a database; and
wherein the host agent server computer is programmed to dynamically set default values for one or more records in the database, when one or more records are added to the database or modified using pre-defined functions set using an interface on a computer monitor of the first user computer, the interface provided by an application computer program running on the first user computer.

6. The apparatus of claim 1
wherein the host agent server computer is programmed to dynamically modify the first user computer to process one or more offers and acceptances provided online through an electronic commerce web site from a computer in an online trading community.

7. The apparatus of claim 1
wherein the host agent server computer is programmed to receive and process swap offers and acceptances placed online wherein the swap offers are made by a first entity operating the first user computer;
wherein the swap offers refer to one or more items listed online for non-monetary exchange for one or more further items;
and wherein the swap acceptances are made by a second entity operating the second user computer.

8. The apparatus of claim 1
wherein the host agent server computer is programmed to receive and process databases online;
wherein the databases are comprised of a plurality of listings of products and services; wherein each of the products and services is identified by an alpha-numerical key code.

9. The apparatus of claim 8
wherein the host agent server computer is programmed to add, store, and delete databases online; and
wherein the databases identify a plurality of users, each of which is identified by a client unique identifier comprising an alpha-numerical key code.

10. The apparatus of claim 1
wherein the host agent server computer is programmed to receive and forward financial transactions by use of a payment authorization gateway online function; and
wherein the host agent server computer processes a plurality of payables from the first user computer and the host agent server computer forwards a plurality of receivables to the second user computer.

11. The process of claim 10
wherein the host agent server computer is programmed to receive and process financial transactions; and
wherein the financial transactions are identified by an alpha-numerical key code assigned by the first user computer.

12. The apparatus of claim 1
wherein the host agent server computer is programmed to receive and process online sales made by offerors from the first user computer;
wherein the online sales involve listings of a plurality of low priced goods and services;
and wherein the online sales involve a plurality of online purchases made by offerees from the second user computer.

13. The apparatus of claim 1
wherein the host agent server computer is programmed to receive and process transactions maximum terms of offer placed by an offeree from the first user computer and sent to the host agent server computer and minimum acceptable terms of offer made by an offeror from the second computer and sent to the host agent server computer.

14. The apparatus of claim 1
wherein the host agent server computer is programmed to receive offers and acceptances placed online by use of a backward looking low bid process;
wherein the backward looking low bid process comprises a request made by offerees from the first user computer to the host agent server computer for products or services at a lowest possible declining bid price and a plurality of low bid offers discretely forwarded back to the host agent server computer by email by offerors acting as suppliers from the second user computer.

15. The apparatus of claim 1
wherein the host agent server computer is programmed to receive and process offers and acceptances placed online from the first user computer by use of a forward looking ascending bid process;
wherein the forward looking ascending bid process comprises offers made by offerees for a plurality of products or services listed online by offerors for the highest possible bid price through the host agent server computer and a plurality of online acceptances authorized by offerors made through the host agent server computer forwarded back to an offeror at the second user computer.

16. The apparatus of claim 1
wherein the host agent server computer is programmed to receive and process a plurality of transactions made online from the first user computer by use of an electronic online shopping market basket process; and
wherein the electronic online shopping market basket process comprises an automated check-out process to add, delete, store, and calculate invoice payables of a plurality of products and services by the host agent server computer forwarded by email to the second user computer.

17. The apparatus of claim 1
wherein the host agent server computer is programmed to receive and process offers and acceptances placed online by moving a computer cursor with a computer mouse and clicking on the computer mouse.

18. The apparatus of claim 1
wherein the host agent server computer is programmed to receive and process a user's feedback from the first user computer wherein the user's feedback includes information referring to the user's satisfaction received from consuming a good or using a service.

19. The apparatus of claim 1
wherein the host agent server computer is programmed to receive and process queries made by the first user computer; and
wherein the host agent server computer is programmed to forward the queries to a customer service representative.

20. The apparatus of claim 3
wherein the databases are of an alpha-numeric nature; and wherein the database comprises an online listing of products and services including description, price, promotion, placement, quantity, reserve price, digital images, location, delivery terms, and payment terms.

21. The apparatus of claim 1
wherein the host agent server computer is programmed to receive, process, and transfer transactions provided by electronic commerce automated trading venues; and
wherein the host agent server computer is programmed to provide over the internet information concerning the transactions as viewable and readable in hyper text mark-up language files.

22. A method comprising
processing transactions between a first user computer and a second user computer.

23. The method of claim 22 further comprising
processing and managing information values and attributes of a non-numeric nature, and information comprising values and attributes of a numeric nature.

24. The method of claim 22 further comprising
automatically compiling, processing, and managing databases from the first user computer and the second user computer using a plurality of programming functions.

25. The method of claim 22 further comprising
causing an electronic commerce global interface in hyper text markup language to be displayed on a computer monitor of the first user computer.

26. The method of claim 22 further comprising
dynamically setting default values for one or more records in a database of a host server computer, when one or more records are added to the database or modified using pre-defined functions set using an interface on a computer monitor of the first user computer, the interface provided by an application computer program running on the first user computer.

27. The method of claim 22 further comprising
dynamically modifying the first user computer to process one or more offers and acceptances provided online through an electronic commerce web site from a computer in an online trading community.

28. The method of claim 22 further comprising
receiving and processing swap offers and acceptances placed online at a host agent server computer wherein the swap offers are made by a first entity operating the first user computer;
wherein the swap offers refer to one or more items listed online for non-monetary exchange for one or more further items;
and wherein the swap acceptances are made by a second entity operating the second user computer.

29. The method of claim 22 further comprising
receiving and process databases online; and
wherein the databases are comprised of a plurality of listings of products and services; wherein each of the products and services is identified by an alpha-numerical key code.

30. The method of claim 29 further comprising
adding, storing, and deleting databases online; and
wherein the databases identify a plurality of users, each of which is identified by a client unique identifier comprising an alpha-numerical key code.

31. The method of claim 22 further comprising
receiving and forwarding financial transactions by use of a payment authorization gateway online function; and
processing a plurality of payables from the first user computer and the forwarding a plurality of receivables to the second user computer.

32. The method of claim 31 further comprising
receiving and processing financial transactions; and
wherein the financial transactions are identified by an alpha-numerical key code assigned by the first user computer.

33. The method of claim 22 further comprising
receiving and processing online sales made by offerors from the first user computer;
wherein the online sales involve listings of a plurality of low priced goods and services;
and wherein the online sales involve a plurality of online purchases made by offerees from the second user computer.

34. The method of claim 22 further comprising
receiving and processing transactions concerning maximum terms of offer placed by an offeree from the first user computer and sent to a host agent server computer and minimum acceptable terms of offer made by an offeror from the second computer and sent to the host agent server computer.

35. The method of claim 22 further comprising
receiving offers and acceptances placed online by use of a backward looking low bid process;
wherein the backward looking low bid process comprises a request made by offerees from the first user computer to a host agent server computer for products or services at a lowest possible declining bid price and a plurality of low bid offers discretely forwarded back to the host agent server computer by email by offerors acting as suppliers from the second user computer.

36. The method of claim 22 further comprising
receiving and processing offers and acceptances placed online from the first user computer by use of a forward looking ascending bid process;
wherein the forward looking ascending bid process comprises offers made by offerees for a plurality of products or services listed online by offerors for the highest possible bid price through a host agent server computer and a plurality of online acceptances authorized by offerors made through the host agent server computer forwarded back to an offeror at the second user computer.

37. The method of claim 22 further comprising
receiving and processing a plurality of transactions made online from the first user computer by use of an electronic online shopping market basket process; and
wherein the electronic online shopping market basket process comprises an automated check-out process to add, delete, store, and calculate invoice payables of a plurality of products and services by a host agent server computer forwarded by email to the second user computer.

38. The method of claim 22 further comprising
receiving and processing offers and acceptances placed online by moving a computer cursor with a computer mouse and clicking on the computer mouse.

39. The method of claim 22 further comprising
receiving and processing a user's feedback from the first user computer wherein the user's feedback includes information referring to the user's satisfaction received from consuming a good or using a service.

40. The method of claim 22 further comprising
receiving and processing queries made by the first user computer; and
forwarding the queries to a customer service representative.

41. The method of claim 24
wherein the databases are of an alpha-numeric nature; and wherein the database comprises an online listing of products and services including description, price, promotion, placement, quantity, reserve price, digital images, location, delivery terms, and payment terms.

42. The method of claim 22
receiving, processing, and transferring transactions provided by electronic commerce automated trading venues; and
providing over the internet information concerning the transactions as viewable and readable in hyper text mark-up language files.
